(19) United States
(12) Patent Application Publication
(10) Pub. No.: US 2008/0208872 A1
(43) Pub. Date: Aug. 28, 2008

(54) ACCESSING MULTIMEDIA

(75) Inventor: Marsal Gavalda, Sandy Springs, GA (US)

Correspondence Address: OCCHIUTI ROHLICEK & TSAO, LLP, 10 FAWCETT STREET, CAMBRIDGE, MA, 02138, US

(73) Assignee: Nexidia Inc., Atlanta, GA (US)

(21) Appl. No.: 12/035,596

(22) Filed: Feb. 22, 2008

Related U.S. Application Data
(60) Provisional application No. 60/891,099, filed on Feb. 22, 2007.

(51) Int. Cl. G06F 17/30

(52) U.S. Cl. 707/10; 707/E17.101

(57) ABSTRACT

An approach to accessing audio or multimedia content uses associated text sources to segment the content and/or to locate entities in the content. A user interface then provides a user with a way to navigate the content in a non-linear manner based on the segmentation or linking of text entities with locations in the content. The user interface can also provide a way to edit segment-specific content and to publish individual segments of the content. The output of the system, for instance the individual segments of annotated content, can be used to syndicate and/or to improve discoverability of the content.

### BACKGROUND

This application claims the benefit of U.S. Provisional Application No. 60/891,099, filed Feb. 22, 2007, and is related to U.S. Pat. No. 7,231,351, issued on Jun. 12, 2007, and titled “Transcript Alignment.” These documents are incorporated herein by reference.

### BACKGROUND

This invention relates to accessing audio and multimedia content.

Audio content, or multimedia content that includes one or more audio tracks, is often available in a form that may not provide a means for easy access by potential users or audiences for the content. For example, multiple segments may be included without demarcated boundaries, which may make it difficult for a user to access a desired segment. In some examples, the audio or multimedia content may be associated with a text source but there is a lack of linking of portions of the text source with particular segments of the content. In some examples, the multimedia is not associated with reliable tags that would make it suitable for access based on content defined by the tags.

With the ever growing amount of audio and multimedia content, for example, available on the Internet, there is a need to be able to access desired parts of that content.

### SUMMARY

In one aspect, in general, an approach to accessing audio or multimedia content uses associated text sources to determine information that is useful for accessing portions of the content. This determined information can relate, for example, to segmentation of items of the content or to determination of annotation tags, such as entities and their locations (e.g., named entities, interesting phrases) in the content. In some examples, a user interface then provides a user a way to navigate the content in a non-linear manner based on the segmentation or linking of entities with locations in the content. In some examples, the determined information is used for preparation of the content for distribution over a variety of channels such as on-line publishing, semantically aware syndication, and search-based discovery.

In another aspect, in general, access to content is provided by accessing a content source that includes audio content, and accessing an associated text source that is associated with the content source. Components of the associated text source are identified and then located in the audio content. Access to the content is then provided according to a result of locating the components.

Aspects can include one or more of the following features.

The method includes generating a data representation of a multimedia presentation that provides access to the identified components in the audio content. For example, the data representation comprises a markup language representation.

The content source comprises a multimedia content source. For example, the multimedia content source comprises a source of audio-video programs.

The component of the text source comprises a segment of the text source and identifying the components includes segmenting the content source.

Providing access to the content according to a result of locating the components includes providing access to segments of the content.

The component of the text source comprises an entity in the text source. Locating the components of the text source in the audio content can include verifying the presence of the entity in the audio content.

The text source comprises at least one of a transcription, close captioning, a text article, teleprompter material, and production notes.

Providing access to the content includes providing a user interface to the content source configured according to the identified components of the associated text source and the locations of said components in the audio content. For example, an editing interface is provided that supports functions including locations of the components in the audio content. As another example, the editing interface supports functions including editing of text associated with the identified components. As yet another example, an interface is provided to a segmentation of the content source, the segmentation being determined according to the identified components of the associated text source and the locations of said components in the audio content. As yet another example, providing the user interface comprises presenting the associated text source with links from portions of the text to corresponding portions of the content source.

Providing access to the content according to a result of locating the components includes storing data based on the result of the locating of the components for at least one of syndication and discovery of the content.

Providing access to the content according to a result of locating the components includes annotating the content.

Providing access to the content according to a result of locating the components includes classifying the content according to information in the associated text source.

In another aspect, in general, a system for providing access to content embodies all the steps of any one of the methods described above.

In another aspect, in general, a computer readable medium comprising software embodied on the medium, the software include instructions for causing an information processing system to perform all the steps of any one of the methods described above.

Advantages can include one or more of the following.

Items of audio content, such as news broadcasts, can be segmented based on associated text without necessarily requiring any or significant human intervention. The associated text does not necessarily have to provide a full transcription of the audio.

The value of existing text-based content can be enhanced by use of selected portions of the text as links to associated audio or multimedia content.

The accuracy of tags provided with multimedia content can be improved by determination whether the tags are truly present in the audio. For example, this may mitigate the effect of intentional mis-tagging of content that may retrieve the content in response to searches that are not truly related to the content.

Other features and advantages of the invention are apparent from the following description, and from the claims.

### DESCRIPTION OF DRAWINGS

FIG. 1 is a block diagram.

### DESCRIPTION

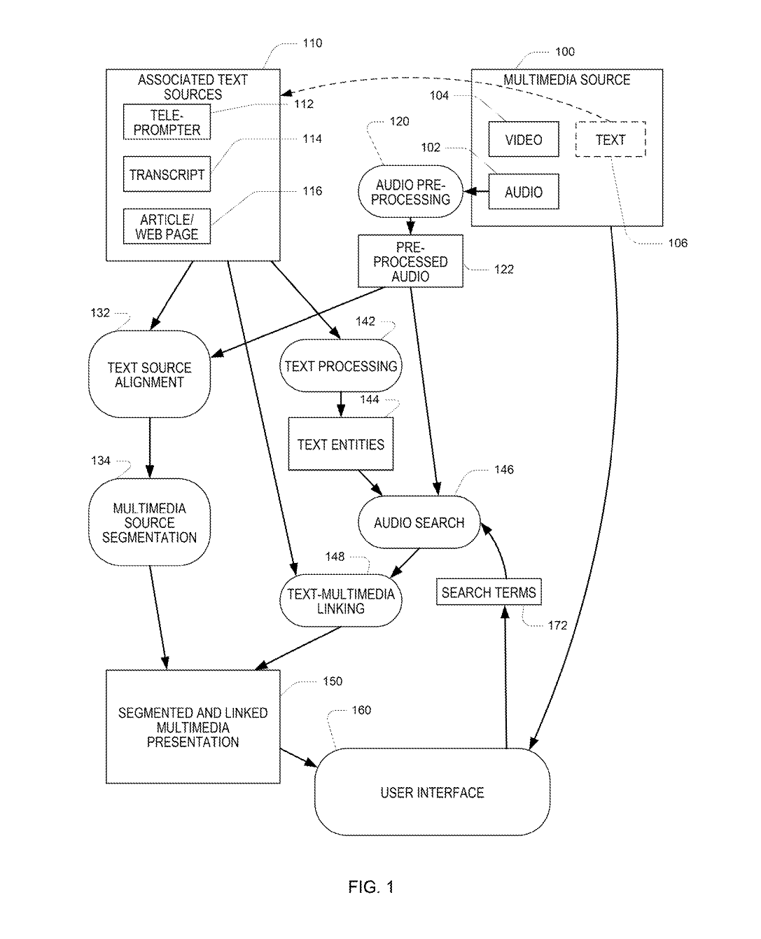

Referring to FIG. 1, a system provides a user interface 160 through which a user can access portions of a multimedia source 100. The multimedia source includes an audio source 102, and typically also includes a corresponding video source 104. (For brevity, hereinafter the term “multimedia” is used to include the case of solely audio, such that “multimedia source” can consist of an audio source with no other type of media). An example of a multimedia source is a television program that has both audio and video content. The multimedia source can include multiple segments that are not explicitly demarcated. For example, a television news show may include multiple stories without intervening scene changes, commercials etc. Optionally, there may be an associated text source 106 that is integrated with the multimedia source, for example, as an integrated text and multimedia document, author supplied metadata (e.g., tags) or other text-based descriptive information, or closed-captioning for a television broadcast, which can be processed in the same manner as separate associated text sources 110.

Examples of the system provide ways for a user to access the multimedia content in a non-linear fashion based on an automated processing of the multimedia content. For example, the system may identify separate segments within the multimedia source and allow the user to select particular segments without having to scan linearly through the source. As another example, the system may let the user specify a query (e.g., in text or by voice) to be located in the audio source and then present portions of the multimedia source that contain instances of the query. The system may also link associated text with portions of the multimedia source, for example, automatically linking headings or particular word sequences in the text with the multimedia source, thereby allowing the user to access related multimedia content while reading the text. These annotative tags can be used to facilitate syndication and discoverability of the tagged multimedia content.

Examples of the system make use of one or more associated text sources 110 to automatically process the multimedia source 100. Examples of associated text sources include teleprompter material 112 used in the production of a television show, transcripts 114 (possibly with errors, omissions or additional text) of the audio 102, or text articles or web pages that are related to but that do not necessarily exactly parallel the audio.

For some of the automated processing, implicit or explicit segmentation of the associated text sources are used to segment the multimedia. For example, in the case of teleprompter material 112, each segment (e.g., news story) may start with a heading and then include text that corresponds to what the announcer was to speak. Similarly, production notes may have headings, as well as notes such as camera instructions, as well as text that may correspond to an initial portion of the announcer's narrative or to a heading for a story. Articles or web pages may have markups or headings that separate texts associated with different segments, even though the text in not necessarily a transcript of the words spoken. Other text sources may be separated into separate files, each associated with a different segment. For example, a web site may include a separate HTML formatted page for each segment.

In one example of automated processing, an associated text source is processed in a text source alignment module 132. For example, an associated text source is parsed or otherwise divided into separate parts, and each part includes a text sequence. The text of each part is aligned to a portion of the audio source, for example, using a procedure described in U.S. Pat. No. 7,231,351, titled “Transcript Alignment.” For that procedure, the audio 102 is pre-processed to form pre-processed audio 122, which enables relatively rapid searching of or alignment to the audio as compared to processing the audio 102 repeatedly. Based on the alignment of the text source and the segments identified in the text source, a source segmentation 134 is applied to the multimedia source to produce a segmented and linked multimedia presentation 150. For example, the multimedia source is divided into separate parts, such as using a separate file for each segment, or an index data structured is formed to enable random access to segments in the multimedia source. The presentation may include text based headings derived from the associated text sources and hyperlinked to the associated segments that were automatically identified.

In another example of automated processing, the associated text sources are passed through a text processing module 142 to produce text entities 144. An example of text processing in automated identification of word sequences corresponding to entities, or other interesting phrases (e.g., “celebrity couple,” “physical custody”). An example of such text processing is performed using commercially available software from Inxight Software, Inc., of Sunnyvale, Calif. Other automated identification of selected or associated word sequences can be based on various approaches including pattern matching and computational linguistic techniques. Putative locations and associated match scores of the text entities may be found in the audio 102 using a wordspotting based audio search module 146. That is, the presence of the text entities is verified using the wordspotting module 146, thereby allowing text entities that do not have corresponding spoken instances in the audio to be ignored or treated differently than entities that are present with sufficient certainty in the audio. Instances of the putative locations of the text entities that occur in the multimedia source with sufficient certainty are then linked to the associated text sources in a text-multimedia linking module 148 to produce text that is part of the multimedia presentation 150 being linked to audio or multimedia content. For example, the associated text sources are converted into an HTML markup form in which the instances of the text entities 144 in the text are linked to portions of the multimedia source. In some examples, selecting such a hyperlink presents both a segment within which the spoken instance of the text entity occurs as well as an indication of (e.g., showing time of occurrence and match score) or a cueing to the location (or multiple locations with there are multiple with sufficiently high match scores) of the text entity within the segment. Example elements of a resulting HTML page include portions of media content, links to media content, descriptions of the content, key words associated with the content, annotations for the content, and named entities in the content.

In another example of automated processing, a user specifies search terms 172 to be located in a multimedia source, which could, for example, be an archive of many news programs each with multiple news segments. The audio search module 146 is used to find putative locations of the terms, and the user interface 160 presents a graphical representation of the segments within which the search terms are found. The user can then browse through the search results and view the associated multimedia. The segmented and linked multimedia presentation 150 can augment the search results, for example, by showing headlines or text associated with the segments within which the search terms were found. These annotations can be presented as descriptive material, links to portions of the content, and/or searchable elements facilitating discovery of the content.

Another type of search is based on text that occurs in an associated text source and that was also present in the audio of the multimedia source. As an example, a text news story may include more words or passages than is found in a corresponding audio report of that news story. The text of the news story is as a source of potential text tags, which may be found for example by a text entity extractor as described above. The set of potential tags may optionally be expanded over the text itself, for example, by application of rules (e.g., stemming rules) or application of a thesaurus. These potential text tags are then used to search the corresponding audio, and if found with relatively high certainty, are associated as tags for the audio source. Therefore, the associated text source is essentially used as a constraint on the possible tags for the audio such that if the automated audio processing detects the tag, there is a high likelihood that the tag was truly present in the audio. The user can then perform a text search on the multimedia source using these verified tags.

The segmentation of the multimedia source, location of text entities, and verification of tags can be applied to provide auxiliary information while the user is viewing a multimedia source. For example, a user may view a number of segments of the multimedia source in a time-linear manner. The segmentation and detected locations of words or tags can, as an example, be used to trigger topic related advertising. Such advertising may be presented in a graphical banner form in proximity to the multimedia display. The segmentation may also be used to insert associated content such as advertising between segments such that a user accessing the multimedia content in a time-linear manner is presented segments with intervening multimedia associated content (e.g., ads). That is, the associated text sources are used for segmentation and location of markers that are used in applications such as content-related advertising.

In some applications, the multimedia content has information regarding possible segment boundaries. For example, silence, music, or other acoustic indicators in the audio track may signal possible segment boundaries. Similarly, video indicators such as scene changes or all black can indicate possible segment boundaries. Such indicators can be used for validation using the approaches described above, or can be used to adjust segment boundaries located using the techniques above in order to improve the accuracy of boundary placement.

In some versions of the system, the approaches described above are part of a video editing system. In an example of such a system, a “long form” of a video program is inputted into the system along with associated text content. The long form program is then segmented according to the techniques described above, and a user is able to manipulate the segmented content. For example, the user may select segments, rearrange them, or assemble a multimedia presentation (e.g., web pages, and indexed audio-video program on a structured medium, etc.) from the segments. The user may also be able to refine the segment boundaries that are found automatically, for example, to improve accuracy and synchronization with the multimedia content. The user may also be able to edit automatically generated headlines or titles to the segments, which were generated based on a matching of the associated text sources with the audio of the multimedia content. In some examples, a full-length broadcast (“long-form”) is automatically converted into segments containing single stories (“web clips”) and each segment is automatically annotated with “tags” (key words or phrases, named entities, etc, verified to occur in the segment) and prepared for distribution in a multiplicity of channels, such as on-line publishing and semantically-aware syndication.

As introduced above, in some examples of the system, the multimedia content is prepared for distribution over one or more channels. For example, the multimedia content is prepared for syndication such that the multimedia content is coupled to annotations, such as text-based metadata that corresponds to words spoken in an audio component of the content, and/or linked text (or text-based markup) that includes one or more links between particular parts of the text and parts of the multimedia content. As another example, the multimedia content is prepared for discovery, for example, by a search engine. For example, a text-based search query that matches metadata that corresponds to words spoken in the audio component or that matches parts of linked text can result in retrieval of the corresponding multimedia content, with or without presentation of the associated text.

A prototype this approach has been applied to television news broadcasts, in which a user can search for and view news stories that are parts or longer news broadcasts using text-based queries.

Other embodiments are within the scope of the following claims.

What is claimed is:

1. A method for providing access to content comprising:
accessing a content source that includes audio content;
accessing an associated text source that is associated with the content source;
identifying components of the associated text source;
locating the components of the text source in the audio content; and
providing access to the content according to a result of locating the components.

2. The method of claim 1 further comprising:
generating a data representation of a multimedia presentation that provides access to the identified components in the audio content.

3. The method of claim 2 wherein the data representation comprises a markup language representation.

4. The method of claim 1 wherein the content source comprises a multimedia content source.

5. The method of claim 4 wherein the multimedia content source comprises a source of audio-video programs.

6. The method of claim 1 wherein the component of the text source comprises a segment of the text source and identifying the components includes segmenting the content source.

7. The method of claim 1 wherein providing access to the content according to a result of locating the components includes providing access to segments of the content.

8. The method of claim 1 wherein the component of the text source comprises an entity in the text source.

9. The method of claim 8 wherein locating the components of the text source in the audio content includes verifying the presence of the entity in the audio content.

10. The method of claim 1 wherein the text source comprises at least one of a transcription, close captioning, a text article, teleprompter material, and production notes.

11. The method of claim 1 wherein providing access to the content includes providing a user interface to the content source configured according to the identified components of the associated text source and the locations of said components in the audio content.

12. The method of claim 11 wherein providing the user interface to the content includes providing an editing interface that supports functions including locations of the components in the audio content.

13. The method of claim 11 wherein providing the user interface to the content includes providing an editing interface that supports functions including editing of text associated with the identified components.

14. The method of claim 11 wherein providing the user interface comprises providing an interface to a segmentation of the content source, the segmentation being determined according to the identified components of the associated text source and the locations of said components in the audio content.

15. The method of claim 11 wherein providing the user interface comprises presenting the associated text source with links from portions of the text to corresponding portions of the content source.

16. The method of claim 1 wherein providing access to the content according to a result of locating the components includes storing data based on the result of the locating of the components for at least one of syndication and discovery of the content.

17. The method of claim 1 wherein providing access to the content according to a result of locating the components includes annotating the content.

18. The method of claim 1 wherein providing access to the content according to a result of locating the components includes classifying the content according to information in the associated text source.

19. A system for providing access to content comprising:
means for identifying components of an associated text source that is associated with the content source, the content source including an audio source;
means for locating the components of the text source in the audio content; and
means for providing access to the content according to a result of locating the components.

20. A computer readable medium comprising software embodied on the medium, the software including instructions for causing an information processing system to:
access a content source that includes audio content;
access an associated text source that is associated with the content source;
identify components of the associated text source;
locate the components of the text source in the audio content; and
provide access to the content according to a result of locating the components.
